(19) United States
(12) Patent Application Publication
(10) Pub. No.: US 2012/0294017 A1
(43) Pub. Date: Nov. 22, 2012

(54) LED Connector and Lighting Device

(76) Inventors: Taisuke Nagasaki, Kanagawa (JP); Yuji Umemura, Tokyo (JP)

(21) Appl. No.: 13/475,273

(22) Filed: May 18, 2012

(30) Foreign Application Priority Data
May 18, 2011 (JP) 2011-111502

(51) Int. Cl. F21V 29/00; H01R 12/70

(52) U.S. Cl. 362/382; 439/56

(57) ABSTRACT

A light emitting diode (LED) connector for connecting to a LED module has a connector board, a module contact and an electrical wire connection section. The connector board has an opening exposing a light emitting section of the LED module, and a trace formed on a contact surface thereof facing the LED module. The connector board covers a portion of the LED module. The module contact on the contact surface is electrically connected to the trace and electrically connectable with a contact pad of the LED module. The electrical wire connection section on the contact surface, is electrically connected to the trace and electrically connectable with an electrical wire.

### CROSS-REFERENCE TO RELATED APPLICATIONS

This application claims the benefit of the filing date under 35 U.S.C. §119(a)-(d) of Japanese Patent Application No. 2011-111502, filed May 18, 2011.

### FIELD OF THE INVENTION

The invention relates to an LED connector for connecting to an LED module and a lighting device using the LED connector.

### BACKGROUND

Light Emitting Diode (LED) modules including LED's offer low power consumption and longer life as compared with a conventional incandescent lamp or a conventional fluorescent tube. They are currently used for lighting fixtures and display devices. Japanese Patent Publication JP 2010-287480A discloses an electrical connector for connecting to such an LED module.

That electrical connector includes an insulating housing, a terminal disposed in the housing and a press-fit pin which is received in the housing. Typically, in a lighting device, the two connectors of an LED module are arranged on a heat sink at the corner portions opposite to each other. Each of the electrical connectors is fixed to the heat sink by inserting the press-fit pin orthogonally.

In the lighting device using the electrical connector of Japanese Patent Publication JP 2010-287480A, the area of the housing which is arranged at the corner portions opposite to each other projects on the light emitting side of the LED module. For this reason, when the lighting device is designed to widen an illumination range or angle, a shadow of the housing may appear in the illuminated range. In addition, it is difficult to make the lighting device in a low profile.

### SUMMARY

The invention has been made in view of the above circumstances and provides an LED connector and a lighting device having a wide illumination range and a low profile.

A light emitting diode (LED) connector for connecting to a LED module has a connector board, a module contact and an electrical wire connection section. The connector board has an opening exposing a light emitting section of the LED module, and a trace formed on a contact surface thereof facing the LED module. The connector board covers a portion of the LED module. The module contact on the contact surface is electrically connected to the trace and electrically connectable with a contact pad of the LED module. The electrical wire connection section on the contact surface, is electrically connected to the trace and electrically connectable with an electrical wire.

### BRIEF DESCRIPTION OF THE DRAWINGS

FIG. 1 is a perspective view of a lighting device according to the invention;

FIG. 2 is an exploded perspective of an LED connector detached from the lighting device illustrated in FIG. 1;

FIG. 3 is a perspective view of an LED module;

FIG. 4 is an underside perspective view of the LED connector illustrated in FIG. 2;

FIG. 5 is a perspective view of the connector board of the LED connector illustrated in FIG. 4;

FIG. 6 is a perspective view of a module contact of the LED connector illustrated in FIG. 4;

FIG. 7 is a perspective view of an electrical wire connection section of the LED connector illustrated in FIG. 4;

FIG. 8 is an exploded perspective view of the electrical wire connection section illustrated in FIG. 4;

FIG. 9 is a cross-sectional view of an electrical wire connected to the electrical wire connection section;

FIG. 10 is a perspective view of a heat sink of the lighting device illustrated in FIG. 1;

FIG. 11 is a view showing a configuration of the lighting device illustrated in FIG. 1, where Part (A) includes a bottom view and Part (B) includes a cross-sectional view taken along the line B-B; and

FIG. 12 is an expanded cross-sectional view schematically illustrating a configuration around the LED module of the lighting device illustrated in FIG. 11.

### DETAILED DESCRIPTION OF THE EMBODIMENT

An exemplary embodiment according to the present invention will be described with reference to the drawings.

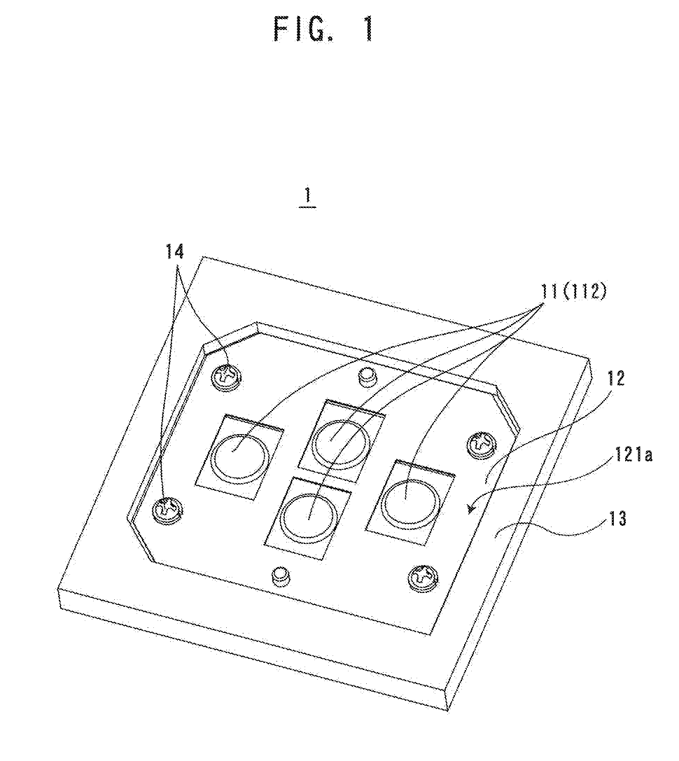

An exemplary lighting device 1 illustrated in FIG. 1 includes four LED modules 11, and an LED connector 12 and a heat sink 13. The LED connector 12 and heat sink 13 are arranged around the LED modules. The LED connector 12 is fixed to the heat sink 13 by screws 14. Light emitting sections 112 of the LED module 11 are illustrated in FIG. 1, where the four light emitting sections 112 are arranged in a common plane. Incidentally, a light transmissive cover (not illustrated) may be attached to the lighting device 1 to cover the four light emitting sections 112.

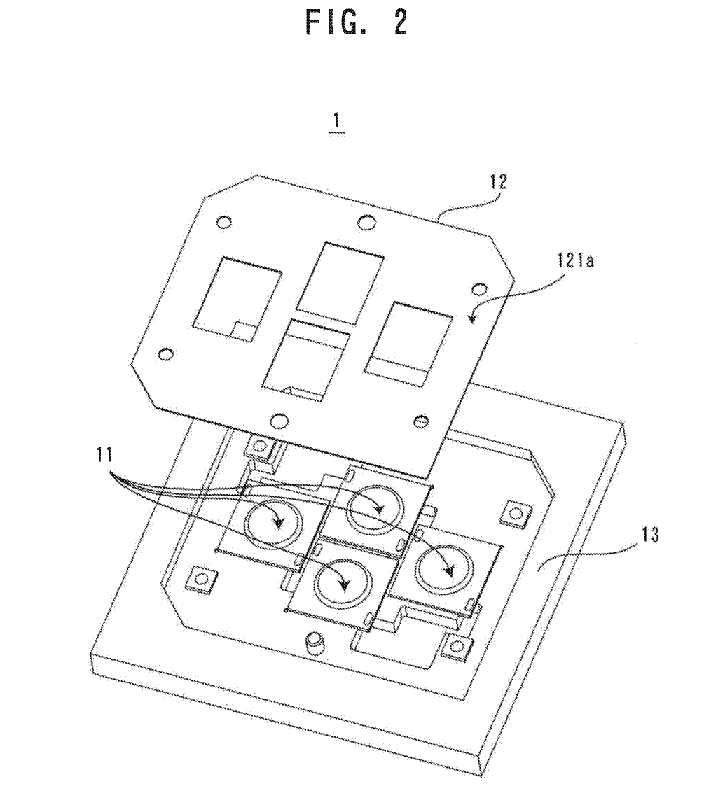

As better shown in FIG. 2, the four LED modules 11 are arranged on the heat sink 13 with the LED connector 12 overlying at least portion of the four LED modules 11.

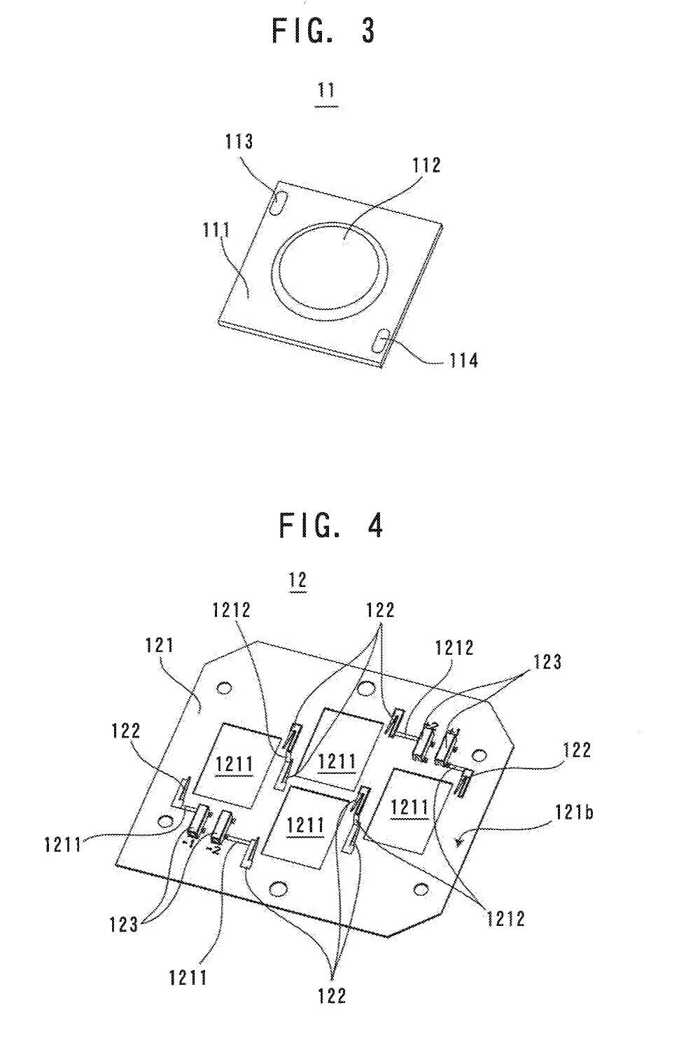

The LED module 11 illustrated in FIG. 3 includes a module board 111 and the light emitting section 112. The module board 11 is formed of insulative material, such as a polymeric material, a ceramic or aluminum with an insulating coating or any other suitable insulative material for carrying an LED. The module board 111 of the embodiment shown has a rectangular shape. The light emitting section 112 is generally disc shaped and is smaller than the module board 111. The light emitting section 112 is formed by sealing an LED element (not illustrated) mounted on the module board 111 with light transmissive material. The light emitting section 112 extends from the module board 111 up to a position in which it is approximately flush with an outer surface 121a of the LED connector 12, when assembled as illustrated in FIG. 1.

In addition, a pair of contact pads 113 and 114 for supplying electrical power to the light emitting section 112 is provided on the module board 111. The contact pads 113 and 114 of the pair are arranged around the light emitting section 112, in the embodiment shown, at positions symmetrical about the light emitting section 112. More specifically, in the embodiment shown, the contact pads 113 and 114 of the pair are arranged at positions near diagonal corners of the module board 111. One of the pair, the contact pad 113, is eclectically connected to an anode of the LED element, and the other of the pair, the contact pad 114 is eclectically connected to a cathode of the LED element.

The LED connector 12 is electrically connected to the LED module 11 (see FIG. 2), and supplies electrical power to the LED module 11 from a power circuit which is not illustrated. The LED connector 12 corresponds to one example of the LED connector according to the present invention.

As shown in FIG. 4, the LED connector 12 includes a connector board 121, module contacts 122 and electrical wire connection sections 123.

The connector board 121 has an outer dimension area that is larger than that of the four LED modules 11 (see FIG. 2). When assembled, a contact surface 121b faces the module board 111. The outer surface 121a illustrated in FIG. 2 is opposite to the contact surface 121b illustrated in FIG. 4.

In the connector board 121, four openings 1211 to expose the light emitting sections 112 (see FIG. 2) of the LED modules 11 are formed to pass through the contact surface 121b and the outer surface 121a. The four light emitting sections 112 are exposed through the four openings 1211, respectively. The connector board 121 therefore exposes the light emitting sections 112 and covers the module board 111 around the light emitting sections 112.

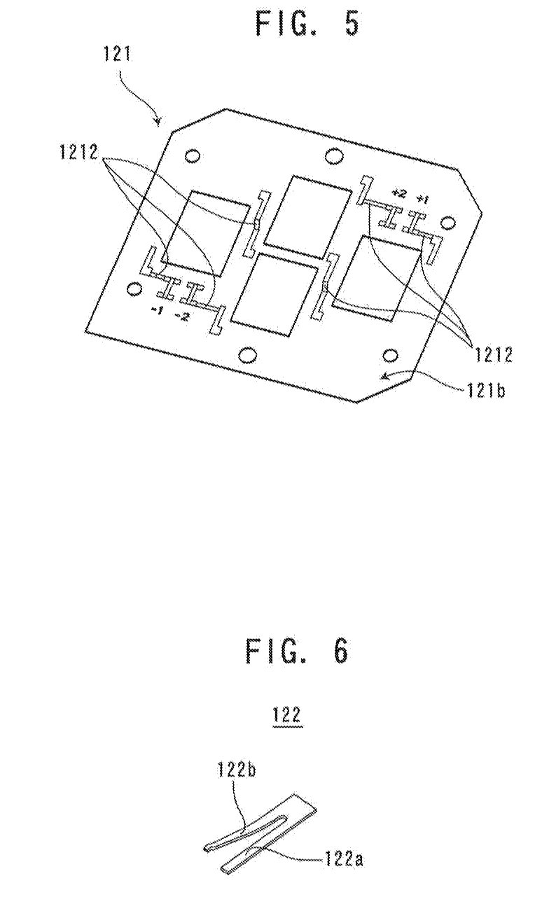

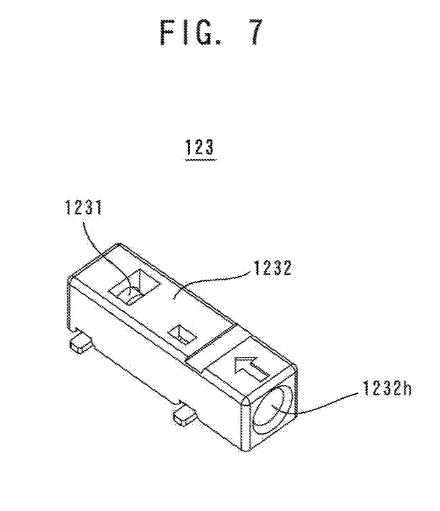

FIG. 5 best shows traces 1212 for supplying electrical power to the LED modules 11 formed to linearly extend on the contact surface 121b of the connector board 121.

Returning to FIG. 4, the module contacts 122 and the electrical wire connection sections 123 are soldered to the traces 1212, thereby being supported by the contact surface 121b of the connector board 121. The module contacts 122 are arranged at first ends of the traces 1212, respectively, and the electrical wire connection sections 123 are arranged at other ends of the traces 1212, respectively. However, as for some of the traces 1212 which are arranged in a center portion, the module contacts 12 are arranged at both ends of the some traces 1212.

The connector board 121 illustrated in FIGS. 4 and 5 is formed such that the traces 1212 are formed on a surface of a board of, for example, glass epoxy resin or phenolic resin by etching or plating, and openings are formed and outer edges removed. In addition, the module contacts 122 and the electrical wire connection sections 123 are soldered to the contact surface 121b of the connector board 121 by, for example, reflow soldering. In other words, the connector board 121 may be manufactured through a process similar to that for a typical printed circuit board.

As shown in FIG. 6, the module contacts 122 are members for making electrical contact with the contact pads 113 or 114 of the LED module 11 to supply electrical power via the traces 1212 (see FIG. 5) to the LED modules. The module contact 1212 is stamped and formed from a metal plate, and is approximately U-shaped. The module contact 122 includes a fixed section 122a which is at one end and a contact arm 122b which is at the other end. The fixed section 122a is soldered to be fixed to the trace 1212 (see FIG. 5) of the connector board 121. The contact arm 122b obliquely extends in a from the connector board 121 as illustrated in FIG. 4. The contact arm 122b elastically contacts a contact pad 113 or 114 (see FIG. 3) of the LED module 11.

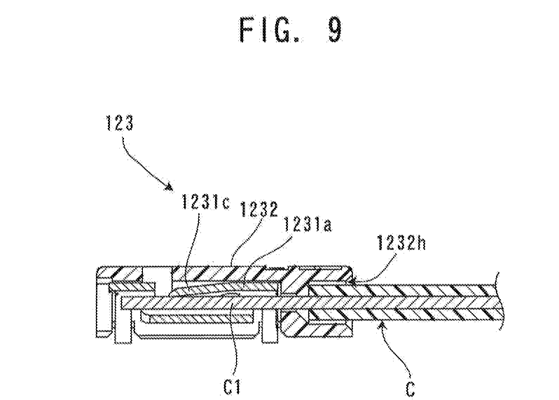

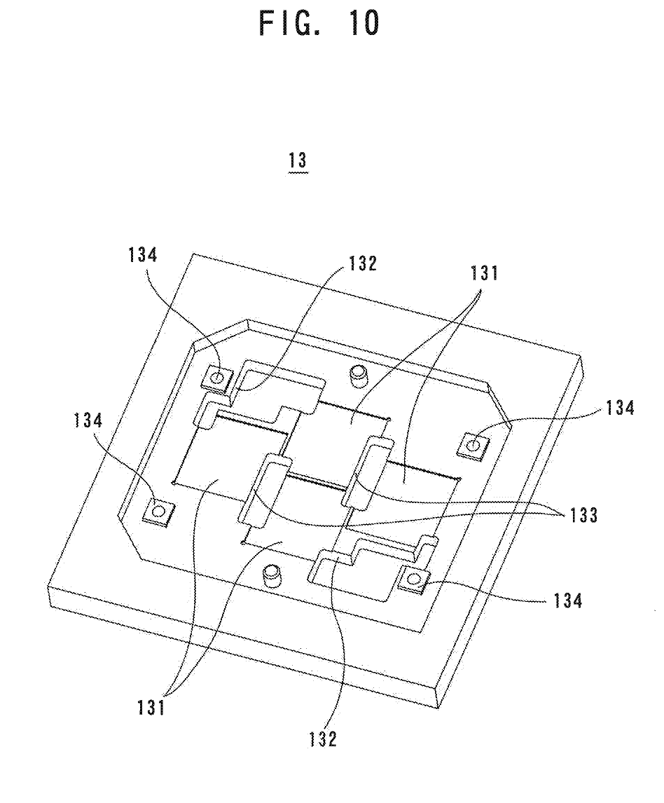

The electrical wire connection section 123 transfers electrical power between an electrical wire C as shown in FIG. 9 and the trace 1212 shown in FIG. 5. The electrical wire connection section 123 includes an electrical wire contact 1231 and an insulating cover 1232 to cover the electrical wire contact 1231.

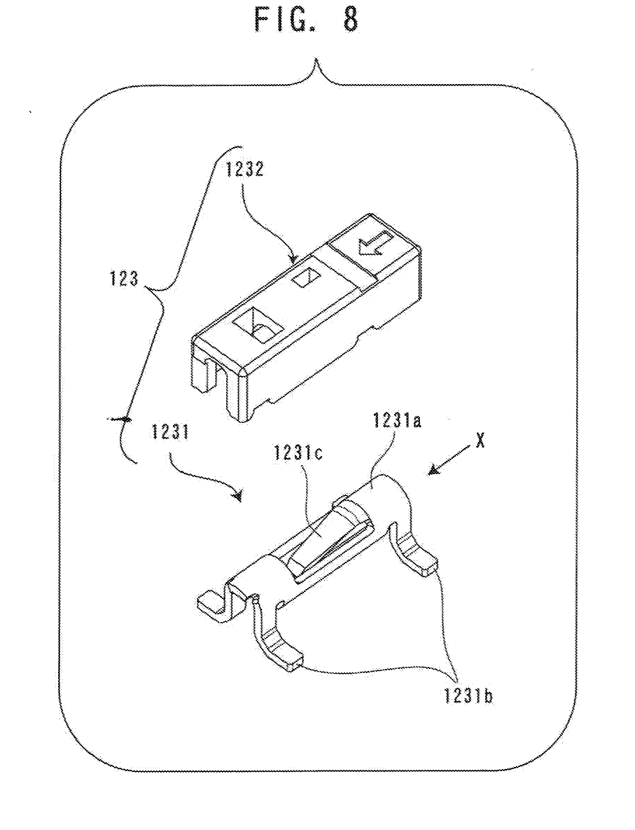

The insulating cover 1232 shown in FIG. 8 is a molded member formed of an insulative material. An insertion opening 1232h into which the electrical wire is inserted is provided at one end face of the insulating cover 1232.

The electrical wire contact 1231 includes an electrical wire insertion section 1231a and feet 1231b. The electrical wire contact 1231 is formed by stamping and forming a metal plate. Feet 1231b are integrally formed with the electrical wire insertion section 1231a.

As shown in FIG. 9, the electrical wire insertion section 1231a is generally cylindrical and receives an electrical wire C in a direction indicated by the arrow X. The four feet 1231b are arranged two each at both ends of the electrical wire insertion section 1231a. Each foot 1231b is soldered to a respective trace 1212 of the connector board 121.

The electrical wire contact 1231 is poke-in contact. A retaining lance 1231c is provided in the electrical wire insertion section 1231a. The retaining lance 1231c is formed such that it extends in the insertion direction X to a free end. At its free end, a tip is formed in an acute angle.

FIG. 9 shows an electrical wire is connected to the electrical wire contact 1231. When the electrical wire C whose sheath is removed at one end and whose core C1 is exposed is inserted into the electrical wire insertion section 1231a through an insertion opening 1232h, the core C1 of the electrical wire C is connected to the electrical wire insertion section 1231a. In addition, the retaining lance 1231c engages the core C1 of the electrical wire C to prevent the electrical wire C from being pulled out.

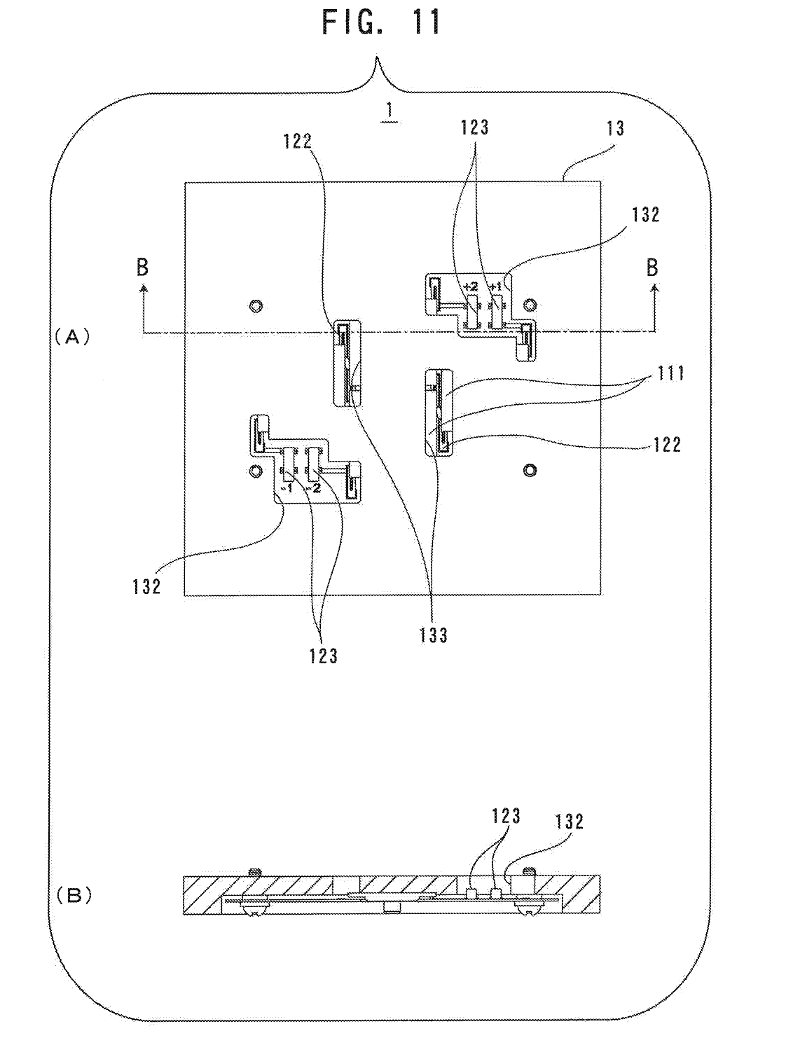

Turning now to FIG. 10, the heat sink 13 is shown and made of a metal material. However, ceramic or resin may be applied as a material of the heat sink 13. In addition, a shape other than that shown in the illustrated embodiment, such as any rectangular shape may be applied as a shape of the heat sink 13 to complement selected arrangements of the LED modules 11 and a design of the lighting device.

Receiving recess sections 131 for receiving the LED modules 11 are provided in the heat sink 13. The receiving recess sections 131 are shallow depth recesses having a size suitable with the module boards 111 of the LED module 11. The LED modules are located by being fitted in the receiving recess sections 131. In addition, the heat sink 13 includes connection portion openings 132 which receive the electrical wire connection section 123 to avoid an interference with the electrical wire connection sections 123, and inspection openings 133 for inspecting a contact state with the LED modules 11. In addition, screw attachment sections 134 to which the screws 14 are attached are provided in the heat sink 13.

In assembling the lighting device 1 illustrated in FIG. 1, first, the LED modules 11 illustrated in FIG. 3 are arranged in the receiving recess sections 131 of the heat sink 13 illustrated in FIG. 10. Next. the LED modules 11 are covered by the LED connector 12 illustrated in FIG. 4. Next, the LED connector 12 is fixed by the screws 14. Next, the electrical wire C is connected. Incidentally, connecting of the electrical wire C may be performed before the LED modules 11 are covered by the LED connector 12.

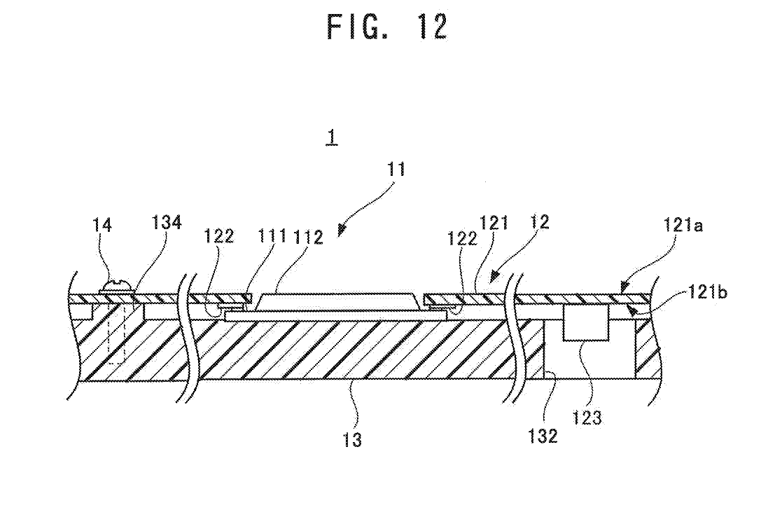

As illustrated in Part (A) of FIG. 11, the module contacts 122 may be inspected through the inspection openings 133 to ensure they make contact with the module board 111. In addition, as illustrated in Part (A) and Part (B) of FIG. 11, the electrical wire connection sections 123 enter into the connection portion openings 132, and thus avoid interference with the electrical wire connection sections 123.

FIG. 12 is an expanded cross-sectional view corresponding to FIG. 1, and turned upside down with respect to Part (B) of FIG. 11. Here it can be see how, in greater detail, the LED modules 11 are arranged on the heat sink 13. The connector board 121 of the LED connector 12 covers the module boards 111 while exposing the light emitting sections 112 of the LED modules 11. The connector board 121 is fixed to the screw attachment sections 134 by the screws 14. The light emitting sections 112 of the LED modules are approximately flush with the outer surface 121a of the LED connector 12.

In the LED connector 12 according to the embodiment, the module boards 111 of the LED modules 11 are held by the connector board 121. Accordingly, light from the light emitting sections 112 is not blocked by the connector board 121. In addition, the light emitting sections 112 of the LED modules 11 extend from the module board 111 up to a position in which the light emitting sections 112 are approximately flush with the outer surface 121a of the LED connector 12. Accordingly, light from the light emitting sections 112 is radiated in a range.

In addition, both of the module contacts 122 and the electrical wire connection sections 123 of the connector board 121 are arranged on the same contact surface 121b as the module boards 111 of the LED modules 11, and it is therefore possible to make the lighting device 1 including the heat sink 13 low profile while achieving wider illumination range from the light emitting sections 112. In addition, also since the electrical wire connection sections 123 enter into the connection portion openings 132 to avoid a contact with the heat sink 13, it is possible to make the lighting device 1 including the heat sink 13 low profile.

In addition, since the LED connector 12 according to the embodiment may be manufactured by a process similar to that of a printed circuit board, it is easy to manufacture the LED connector 12 as compared with using a resin mold housing. In addition, even if a shape, the number of pieces arranged or an arrangement position of LED module in the lighting device is changed, it may be addressed by changing the traces of the module board and arrangements of the module contacts and the electrical wire connection sections.

Incidentally, in the above-described embodiment, four LED modules 11 are illustrated. However, the present invention is not limited to this, and, for example, the number of the LED modules may be two or more other than four, or may be one.

In addition, the connector board according to the above-described embodiment is a connector board formed by forming a metal trace on a board made of glass epoxy or phenolic resin. However, the present invention is not limited to this. The connector board may be, for example, one in which an insulating layer is provided on a surface of a metal plate, and a trace is formed thereon.

In addition, the LED module according to the above-described embodiment includes the light emitting section 112 having a disc shape and the pair of contact pads 113 which are symmetrically arranged around the light emitting section 112. However, the present invention is not limited to this, the shape of the light emitting section may be, for example, a rectangular plate shape or a spherical shape. In addition, the contact pad may be arranged on one side of the light emitting section.

In addition, the light emitting sections 112 of the LED module 11 according to the above-described embodiment extend from the module board 111 up to the position in which the light emitting sections 112 are approximately flush with the outer surface 121a of the LED connector 12. However, the present invention is not limited to this. The light emitting section may be one which projects from the LED connector, or may be one which is recessed from the surface of the LED connector.

In addition, the heat sink 13 according to above-described embodiment is provided with the connection portion opening 132 which is a through hole to avoid an interference with the electrical wire connection section 123. However, the present invention is not limited to this. The opening to avoid an interference with the electrical wire connection section may be, for example, a groove having a bottom.

Further, the above-described electrical wire connection section 123 includes a poke in type electrical wire contact 1231. However, the electrical wire connection section is not limited to this, and may be any other type of wire-to-board connection, for example, a crimp contact on a side of the electrical wire C which is connected to a receptacle contact on the connector board 121. Or, the electrical wire connection section may be a board-to-board connection, for example, an assembly including a pin provided on the connector board 121, and a receptacle contact mounted on a board such as an FPC of a wire side, into which the pin is inserted.

What is claimed is:

1. A light emitting diode (LED) connector for connecting to a LED module comprising:
a connector board having an opening exposing a light emitting section of the LED module, and a trace formed on a contact surface thereof facing the LED module, the connector board covering a portion of the LED module;
a module contact on the contact surface being electrically connected to the trace and electrically connectable with a contact pad of the LED module;
an electrical wire connection section on the contact surface, being electrically connected to the trace and electrically connectable with an electrical wire.

2. The LED connector according to claim 1, wherein the light emitting section is arranged to extend from the LED module up to a position in which it is approximately flush with an outer surface of the connector board opposite to the contact surface.

3. The LED connector according to claim 1, wherein the module contact has a fixed section at one end and a contact arm at another other end.

4. The LED connector according to claim 3, wherein the fixed end is soldered to the trace.

5. The LED connector according to claim 4, wherein the contact arm elastically contacts the contact pad.

6. The LED connector according to claim 5, wherein the contact arm is approximately U-shaped.

7. The LED connector according to claim 1, wherein the electrical wire connection section comprises an electrical wire contact and an insulating cover over the electrical wire contact.

8. The LED connector according to claim 1, wherein the electrical wire contact has an electrical wire insertion section being generally cylindrical and having a retaining lance extending therein to engage an inserted wire.

9. The LED connector according to claim 8, wherein the electrical wire insertion section further comprises feet being soldered to the traces.

10. A lighting device comprising:
a light emitting diode (LED) module having a module board, a light emitting section and a contact pad for supplying electrical power to the light emitting section, the light emitting section and the contact pad being arranged on the module board;
a heat sink supporting the LED module and having an opening; and
a LED connector arranged over the LED module and having: a connector board having an opening exposing a light emitting section of the LED module, and a trace formed on a contact surface thereof facing the LED module; a module contact on the contact surface being electrically connected to the trace and electrically connected with the contact pad; an electrical wire connection section on the contact surface and exposed through the opening, the electrical wire connection section being electrically connected to the trace and electrically connected with an electrical wire.

11. The lighting device according to claim 10, wherein the light emitting section is arranged to extend from the LED module up to a position in which it is approximately flush with an outer surface of the connector board opposite to the contact surface.

12. The lighting device according to claim 10, wherein the module contact has a fixed section at one end and a contact arm at another other end.

13. The lighting device according to claim 12, wherein the fixed end is soldered to the trace.

14. The lighting device according to claim 13, wherein the contact arm elastically contacts the contact pad.

15. The lighting device according to claim 14, wherein the contact arm is approximately U-shaped.

16. The lighting device according to claim 10, wherein the electrical wire connection section comprises an electrical wire contact and an insulating cover over the electrical wire contact.

17. The lighting device according to claim 10, wherein the electrical wire contact has an electrical wire insertion section being generally cylindrical and having a retaining lance extending therein to engage an inserted wire.

18. The lighting device according to claim 17, wherein the electrical wire insertion section further comprises feet being soldered to the traces.
